(19) United States
(12) Patent Application Publication
(10) Pub. No.: US 2009/0272242 A1
(43) Pub. Date: Nov. 5, 2009

(54) CUTTING MACHINE

(75) Inventors: Atsuhito Okada, Hiroshima (JP); Katsutoshi Kouchiyama, Hiroshima (JP)

Correspondence Address: YOUNG & THOMPSON, 209 Madison Street, Suite 500, ALEXANDRIA, VA, 22314, US

(73) Assignee: Ryobi Ltd., Fuchu-Shi (JP)

(21) Appl. No.: 11/994,651

(22) PCT Filed: Jul. 14, 2006
(86) PCT No.: PCT/JP2006/314057

§ 371 Date: Jan. 4, 2008

(30) Foreign Application Priority Data
Jul. 20, 2005 (JP) 2005-210291

(51) Int. Cl. B26D 1/143

(52) U.S. Cl. 83/471.2

(57) ABSTRACT

A motor (6) having a motor shaft (6a), a circular saw blade (1) having a saw blade shaft (1a) parallel to the motor shaft, a housing (2) accommodating the motor and the circular saw blade and having a handle (14) at the rear thereof, a surface plate (4) connected to the housing (2), a start end gear (7a) fixed to the motor shaft, a terminal end gear (7b) fixed to the saw blade shaft, and an intermediate gear (7c, 7d) located between the start end gear and the terminal end gear are included. The start end gear, terminal end gear, and the intermediate gear are meshed each other to transmit, to the circular saw blade, rotation of the motor to be decelerated as rotation in the identical direction. The intermediate gear is positioned rearward of the plane including the motor shaft and the saw blade shaft.

### TECHNICAL FIELD

The invention relates to a cutting machine such as a portable circular saw for reducing a reaction caused when a motor thereof is actuated.

### BACKGROUND ART

In a portable circular saw which is one kind of the cutting machines, a motor and the circular saw blade are accommodated in a housing such that a motor shaft and a saw blade shaft are in parallel to each other. A surface plate is connected to the housing. A start end gear is fixed to the motor shaft, a terminal end gear is fixed to the saw blade shaft, and an intermediate gear is placed between these gears. The rotation of the motor is decelerated and transmitted to the circular saw blade by meshing between these gears (for example, see Patent Documents 1 and 2).

The portable circular saw includes a controller to control the motor such that the number of revolutions of the motor becomes constant irrespective of variation in load. This controller includes a revolution detecting sensor which projects into a flow path of cooling air toward the outer peripheral edge of a cooling fan of the motor. A fan casing of the cooling fan includes a baffle portion formed inside thereof so that the revolution detecting sensor does not block the flow of the cooling air (for example, see Patent Document 3).

Patent Document 1: Japanese Patent Application Laid-open No. 2002-160121

Patent Document 2: Japanese Patent Application Laid-open No. H09-141602

Patent Document 3: Japanese Patent Application Laid-open No. 2004-155097

### DISCLOSURE OF THE INVENTION

According to the portable circular saw described in the Patent Document 1, the motor and the circular saw blade rotate in the identical direction, and a large reaction is applied to the housing and the surface plate when the motor is actuated. That is, to describe with FIGS. 1 and 3 of the present application, when a motor 6 and a circular saw blade 1 rotate in the direction of an arrow A, reaction is produced in the direction of an arrow B with respect to a housing 2 and a surface plate 4. When an operator grasps a handle 14 with his or her hand, the portable circular saw is biased in the clockwise direction in FIG. 3, and the front side of the circular saw tries to lower. Thus, the operator feels a sense of discomfort and this may be an obstacle to precise machining.

In the portable circular saw described in the Patent Document 2, the motor and the circular saw blade rotate in the opposite directions from each other. An intermediate gear is located in front of a plane including a motor shaft and a saw blade shaft, and the saw blade shaft is located in front of the motor shaft. Such location causes a portion of the saw in front of the motor shaft heavier, and deteriorates the weight balance when an operator grasps the handle. Further, the portable circular saw needs many intermediate gears, and the number of parts is increased so that the weight is increased as a whole, deteriorating operability thereof.

The baffle portion of the cooling fan in the portable circular saw described in the Patent Document 3 is formed as a baffle plate extending long in the fan casing. This structure causes the shape of the fan casing so complicated that the fan casing is difficult to machine, and reduces the volume of air supplied by the cooling fan.

The invention is directed to provide a cutting machine to overcome these problems.

The aspect of the invention provides a cutting machine including the following elements. The cutting machine includes a motor (6) having a motor shaft (6a). The cutting machine includes a circular saw blade (1) having a saw blade shaft (1a) parallel to the motor shaft (6a). The cutting machine includes a housing (2) accommodating the motor (6) and the circular saw blade (1) and having a handle (14) at the rear thereof. The cutting machine includes a surface plate (4) connected to the housing (2). The cutting machine includes a start end gear (7a) fixed to the motor shaft (6a). The cutting machine includes a terminal end gear (7b) fixed to the saw blade shaft (1a). The cutting machine includes an intermediate gear (7c, 7d) located between the start end gear (7a) and the terminal end gear (7b). The start end gear (7a), terminal end gear (7b), and the intermediate gear (7c, 7d) are meshed each other to transmit, to the circular saw blade (1), rotation of the motor (6) to be decelerated as rotation in the identical direction. The intermediate gear (7c, 7d) is positioned rearward of the plane including the motor shaft (6a) and the saw blade shaft (1a).

In the above aspect, the terminal end gear (7b) may be positioned rearward of the motor shaft (6a).

The motor may have a soft start function.

According to the aspect of the invention, the location of the intermediate gear (7c, 7d) allows the front side of the motor shaft (6a) to be lighter in weight and the rear side of the motor shaft (6a) to be heavier in weight, reducing the reaction against the housing (2) and surface plate (4) due to rotation of the motor (6) and the circular saw blade (1) during the initial phase of start even if the cutting machine have the motor (6) and the circular saw blade (1) to rotate in the identical direction. Thus, the housing (2) and the motor (6) are easily held in a certain position, an operator performs precise machining without feeling a sense of discomfort, and the operability is improved.

The location of the terminal end gear (7b) further reduces the reaction against the housing (2) and the surface plate (4) due to rotation of the motor (6) and the circular saw blade (1) in the identical direction.

The soft start function smoothly starts the motor (6), further reducing the reaction.

### BRIEF DESCRIPTION OF THE DRAWINGS

FIG. 1 is a partially cut-away plan view of a cutting machine according to an embodiment of the invention, wherein F1 indicates the front, R1 indicates the back, R2 indicate the right, and L2 indicates the left.

FIG. 2 is a front view of the cutting machine illustrated in FIG. 1.

FIG. 3 is a front view of the cutting machine illustrated in FIG. 2 from which a part of a cover of a housing is removed.

FIG. 4 is a vertical sectional view of the cutting machine illustrated in FIG. 1.

FIG. 5 is a graph for describing a soft start function of a motor.

FIG. 6 is a partially cut-away vertical sectional view illustrating a controller of the motor.

FIG. 7 is a sectional view taken along the line VII-VII in FIG. 6.

FIG. 8 is a perspective view illustrating a fan casing of a cooling fan device of the motor together with a case of the controller.

FIGS. 9(A) and 9(B) are a front view and a side view of a case of the controller, respectively.

FIGS. 10(A) and 10(B) are a front view and a side view of a modification of the case of the controller, respectively.

### BEST MODE FOR CARRYING OUT THE INVENTION

Best modes for carrying out the invention are described below with reference to the drawings.

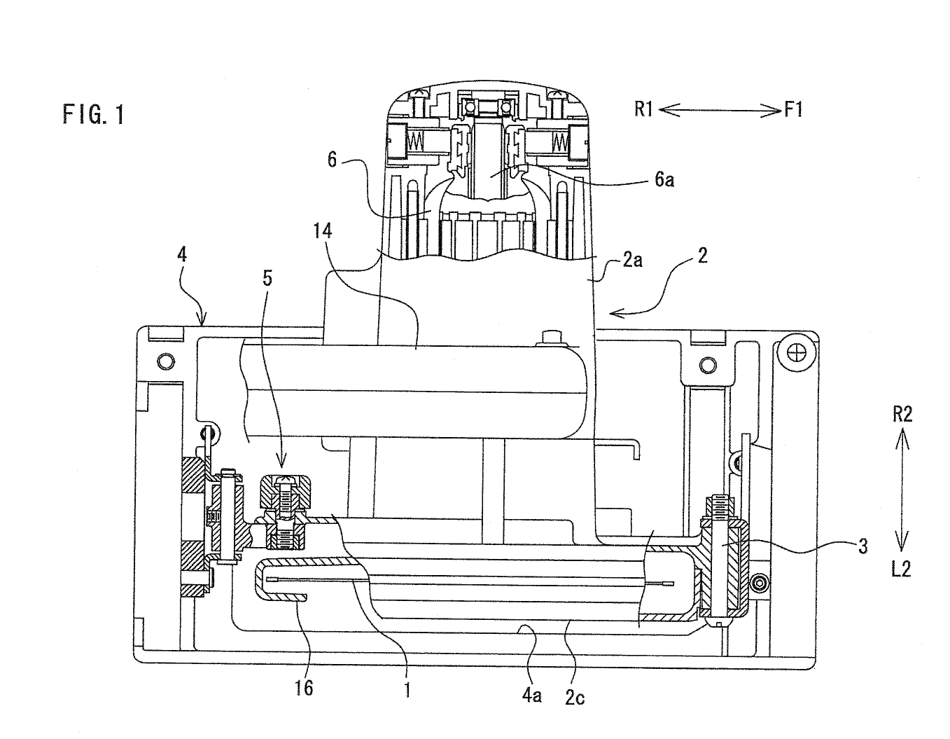

As illustrated in FIGS. 1 to 4, a portable circular saw which is one kind of cutting machines includes a circular saw blade 1 and a housing 2 accommodating a driving portion of the circular saw blade 1. The circular saw includes a surface plate 4 which is located below the housing 2, and rotatably connected to the front end of the housing 2 by a pivot 3. The circular saw includes a cutting-depth adjusting device 5 which permits rotation of the surface plate 4 around the pivot 3, and increases and decreases a projecting amount of the circular saw blade 1 below the surface plate 4.

As illustrated in FIGS. 1 to 4, the housing 2 includes a motor case 2a which accommodates a motor 6 of the driving portion. The housing 2 includes a gear box 2b which accommodates a power transmission gear train 7 of the driving portion. The housing 2 includes a cover 2c which covers the substantially upper half of the circular saw blade 1, and the like. The motor case 2a, the gear box 2b and the cover 2c are integrally formed.

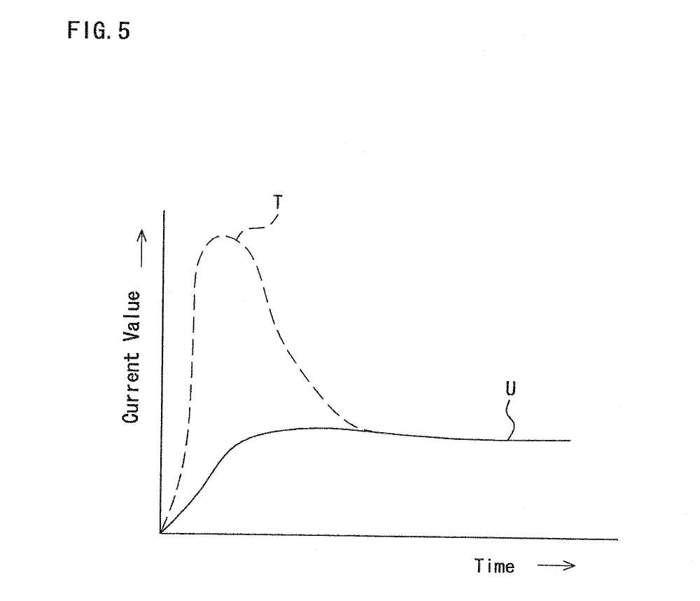

The motor 6 has a soft start function. Although not illustrated, when the motor 6 is actuated, a detector detects a value of current flowing through a coil and a resistance value of the coil is temporarily increased by a CPU using a detection signal from the detector. Accordingly, inrush current T at the initial stage of actuation of the motor 6 shown with a broken line in FIG. 5 is eliminated, and stable current U is supplied to the coil from be beginning as shown with a solid line in FIG. 5. Therefore, the motor 6 is quietly actuated, and a stable cutting operation may be carried out from the beginning.

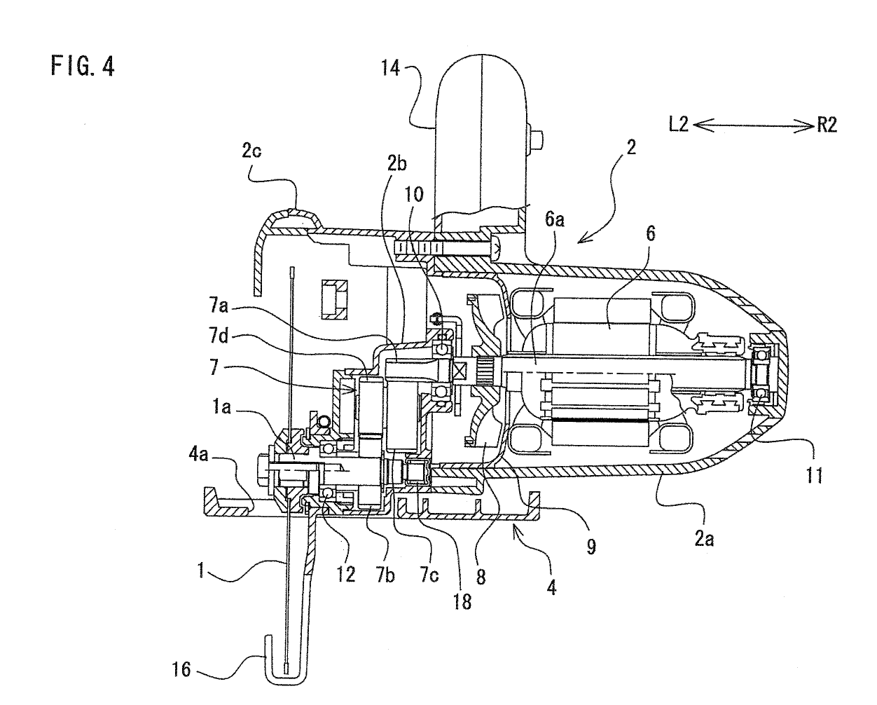

As illustrated in FIG. 4, the motor case 2a extends in the transverse direction of the portable circular saw, and the motor 6 is transversely placed in the motor case 2a. The motor 6 is provided with a cooling fan device. That is, a cooling fan 8 is fixed to a motor shaft 6a, and a fan casing 9 covering the cooling fan 8 is inserted in a cavity of the motor case 2a and fixed.

The gear box 2b is located on the left end of the motor case 2a in the Figure, and is fixed to the motor case 2a by a screw or the like. Both ends of the motor shaft 6a are supported by the right end of the gear box 2b and the right end of the motor case 2a through bearings 10 and 11, respectively. The left end of the motor shaft 6a includes a start end gear 7a. The start end gear 7a is inserted in the gear box 2b. The bottom of the gear box 2b is positioned so as to be lower than the bottom of the motor case 2a. The saw blade shaft 1a of the circular saw blade 1 is supported at that portion by a bearing 12 and a needle bearing 18. Accordingly, a substantially lower half of the circular saw blade 1 projects downward from the lower end of the housing 2. The saw blade shaft 1a has an end on the side of an intermediate gear 7c, and this end is supported by the needle bearing 18. With this configuration, a center distance between the motor shaft 6a and the saw blade shaft 1a is shortened, reducing the circular saw in size and weight.

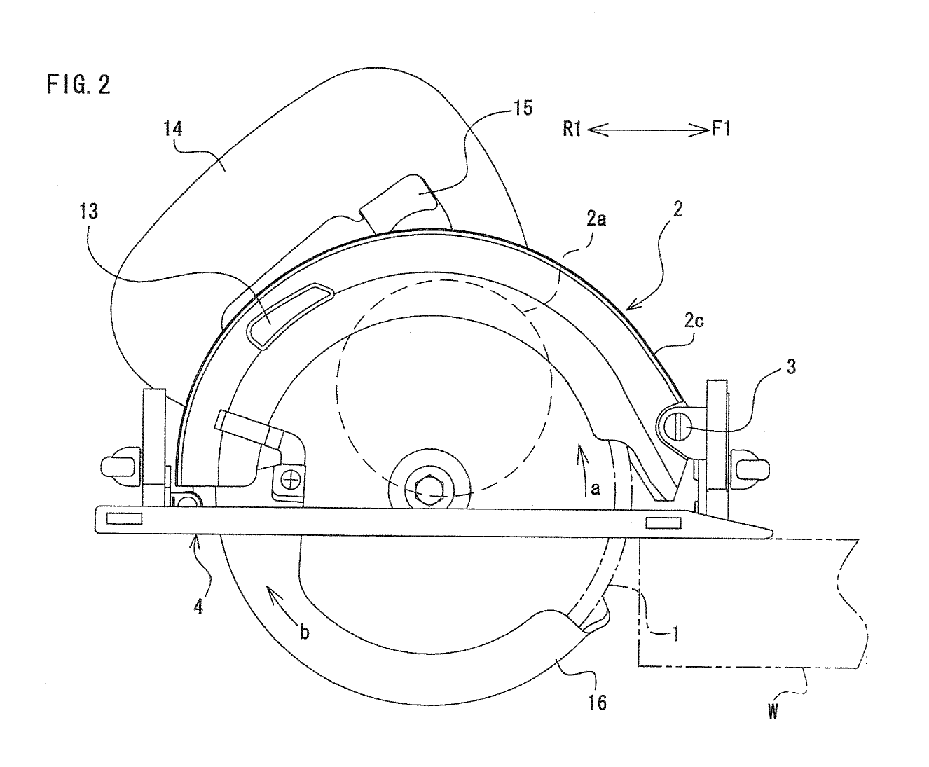

A terminal end gear 7b is fixed to a position where the saw blade shaft 1a is inserted in the gear box 2b. The gear box 2b accommodates intermediate gears 7c and 7d which connects between the start end gear 7a and the terminal end gear 7b. The intermediate gears 7c and 7d are fixed coaxially. One of the intermediate gears 7c and 7d may be omitted to be an idle gear which is not involved in a velocity ratio. The cover 2c curves along the outer periphery of the circular saw blade 1, and is split in the transverse direction of the portable circular saw. The right half of the cover 2c is integrally formed with the gear box 2b so as to continue into the gear box 2b, and the left half thereof is fixed to the right half by a screw or the like. As illustrated in FIG. 2, the left half has a discharge opening 13 for swarf.

As illustrated in FIGS. 1 and 4, a handle 14 for operating the portable circular saw is located on the upper rear portion of the motor case 2a of the housing 2. The handle 14 includes a switch lever 15 for turning ON and OFF the rotation of the circular saw blade 1 of the portable circular saw. The left end of the gear box 2b which supports the saw blade shaft 1a of the circular saw blade 1 is formed as a cylindrical shaft. This cylindrical shaft rotatably supports a safe cover 16 covering the lower half of the circular saw blade 1. When a workpiece W is to be cut, the safe cover 16 is pushed by the workpiece W and is turned into the cover 2c around the cylindrical shaft.

As illustrated in FIGS. 1 to 4, the surface plate 4 is located below the housing 2 so as to extend in the anteroposterior direction of the portable circular saw. The surface plate 4 is provided at its lower surface with a smooth contact surface which is brought into contact with the workpiece W. The surface plate 4 is provided at its central portion with an opening 4a for the circular saw 1, the safe cover 16, and the like to pass therethrough.

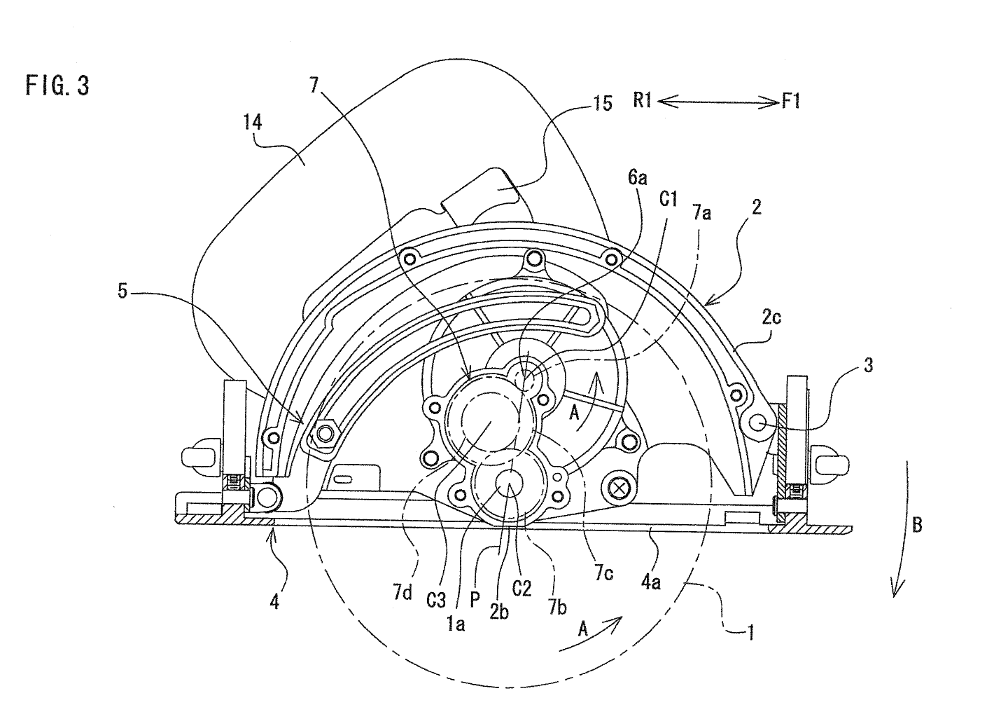

As illustrated in FIGS. 3 and 4, the motor 6 and the circular saw blade 1 are accommodated in the housing 2 such that the motor shaft 6a and the saw blade shaft 1a are in parallel to each other. The surface plate 4 is connected to the housing 2 on the opposite side from the motor shaft 6a with respect to the saw blade shaft 1a. The start end gear 7a fixed to the motor shaft 6a and the terminal end gear 7b fixed to the saw blade shaft 1a mesh with the intermediate gears 7c and 7d, respectively. This meshing decelerates the rotation of the motor 6 and transmits the decelerated rotation to the circular saw blade 1. Therefore, as indicated with an arrow A in FIG. 3, the rotation of the motor 6 is transmitted to the circular saw blade 1 as rotation in the identical direction. Therefore, according to the conventional structure of the driving portion, reaction is produced against the housing 2 and the surface plate 4 in the direction indicated with the arrow B at the initial stage of actuation of the motor 6. For reducing the reaction, in this embodiment, the shift centers C3 of the intermediate gears 7c and 7d are displaced from a plane P including the shaft center C1 of the motor shaft 6a and the shaft center C2 of the saw blade shaft 1a as illustrated in FIG. 3. More specifically, the shaft centers C3 of the intermediate gears 7c and 7d are displaced rearward R1 from the plane P and closer to the handle 14. With this structure, reaction produced when the motor 6 is actuated is absorbed and reduced by the weights of the intermediate gears 7c and 7d. By the reduction in reaction, the housing 2 and the surface plate 4 are held at constant positions with the handle 14 held by a hand, from the beginning of actuation of the motor 6. Therefore, the operator does not feel a sense of discomfort and carries out precise machining, which enhances the operability. As illustrated in FIG. 3, the saw blade shaft 1a which fixes the terminal end gear 7b may be positioned rearward R1 of the motor shaft 6a. Accordingly, reaction is further reduced.

In FIG. 3, directions in which the surface plate 4 extends are anteroposterior directions F1 and R1. The handle 14 is displaced rearward R1 of the motor shaft 6a or toward one direction. That is, the grip of the handle 14 is located on the rear side R1 with respect to the shaft center C1 of the motor shaft 6a. The intermediate gears 7c and 7d, or a group of the gears 7b, 7c, and 7d connected to start end gear 7a are displaced closer to the rear side R1 than the motor shaft 6a. That is, the shaft centers C3 of the intermediate gears 7c and 7d are located closer to the rear side R1 than the shaft center C1 of the motor shaft 6a, and closer to the handle 14. The arrangement of the intermediate gears 7c and 7d shifts a mass center of the cutting machine toward the rear side R1, and brings the mass center close to the handle 14. Accordingly, a mass moment of the cutting machine with respect to the handle 14 is reduced, a torque applied to the handle 14 is reduced, and a burden on the user is reduced.

The reaction is further reduced by making the weights of the intermediate gears 7c and 7d more than those of the terminal end gear 7b or the start end gear 7a. For example, in order to decelerate the intermediate gear 7d which is meshed with the terminal end gear 7b, the number of teeth of the intermediate gear 7d must be less than that of the terminal end gear 7b. The weight of the intermediate gear 7d may be increased by making a rack shift coefficient of the intermediate gear 7d higher than that of the terminal end gear 7b to increase the outer diameter of the intermediate gear 7d without changing the number of teeth of the intermediate gear 7d. Contrarily, it is also possible to reduce the weight of the terminal end gear 7b by reducing the rack shift coefficient of the terminal end gear 7b and reduce the outer diameter thereof without changing the number of teeth of the terminal end gear 7b. This further reduces reaction against the housing 2 and the surface plate 4 caused when the motor 6 and the circular saw blade 1 rotate in the identical direction.

As illustrated in FIGS. 3 and 4, the intermediate gears 7c and 7d of the transmission gear train 7 are accommodated between the saw blade shaft 1a and the motor shaft 6a in the driving portion. This arrangement forms a clearance between the circular saw blade 1 and the motor shaft 6a. That is, the terminal end gear 7b is located below the start end gear 7a of the driving portion. The intermediate gears 7c and 7d are interposed in tiers between the start end gear 7a and the terminal end gear 7b. The gear box 2b is formed along a profile of the transmission gear train 7.

The portable circular saw includes the controller which controls the motor 6 such that the revolution number of the motor 6 is constant irrespective of variation in load in the cutting operation.

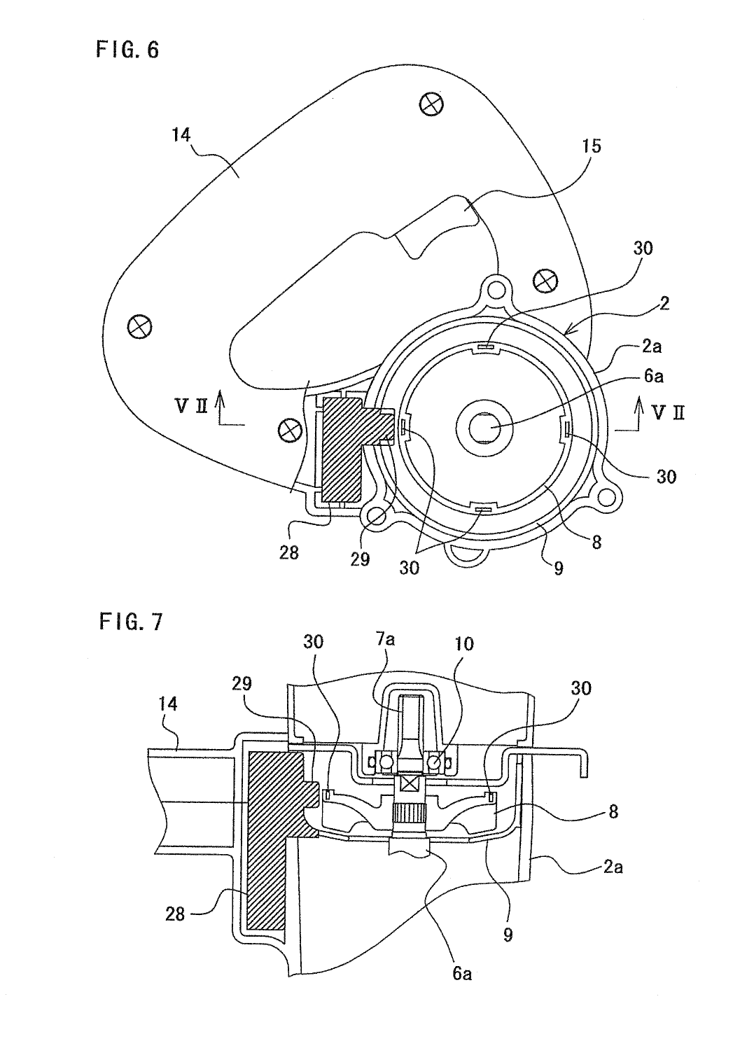

As illustrated in FIGS. 6 to 9, a circuit body (not illustrated) of the controller is accommodated in a case 28, and the circuit body is fixed to a position in the housing 2 proximate to the cooling fan device with the case 28 inbetween. The circuit body is provided with a revolution detecting sensor 29. The revolution detecting sensor 29 projects outside from the case 28 and extends into the fan casing 9. A proximity element 30 such as a magnet is mounted on an outer peripheral edge of the cooling fan 8 so as to be opposed to the revolution detecting sensor 29. When the cooling fan 8 rotates with the motor 6 rotating, the revolution detecting sensor 29 catches the proximity element 30. Accordingly, the circuit body calculates the revolution number of the motor 6, and controls the revolution number of the motor 6 to a desired value. Other detection methods may of course be employed as the revolution detecting sensor 29.

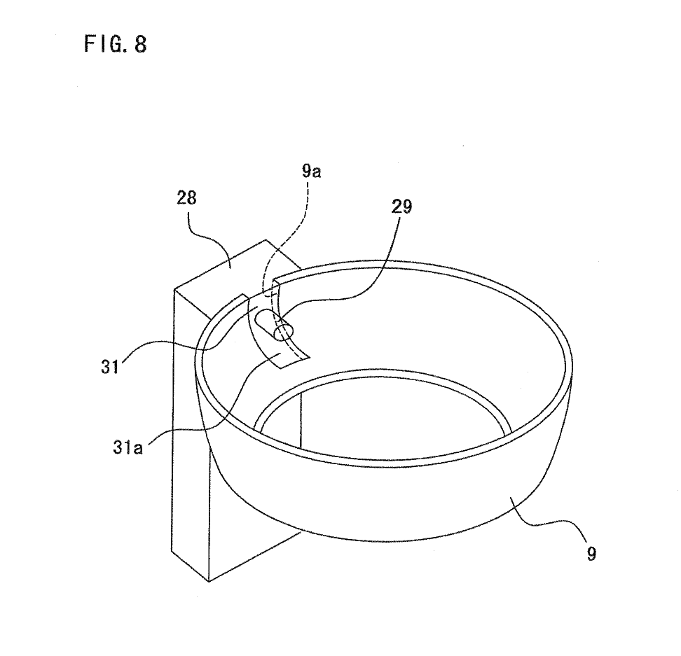

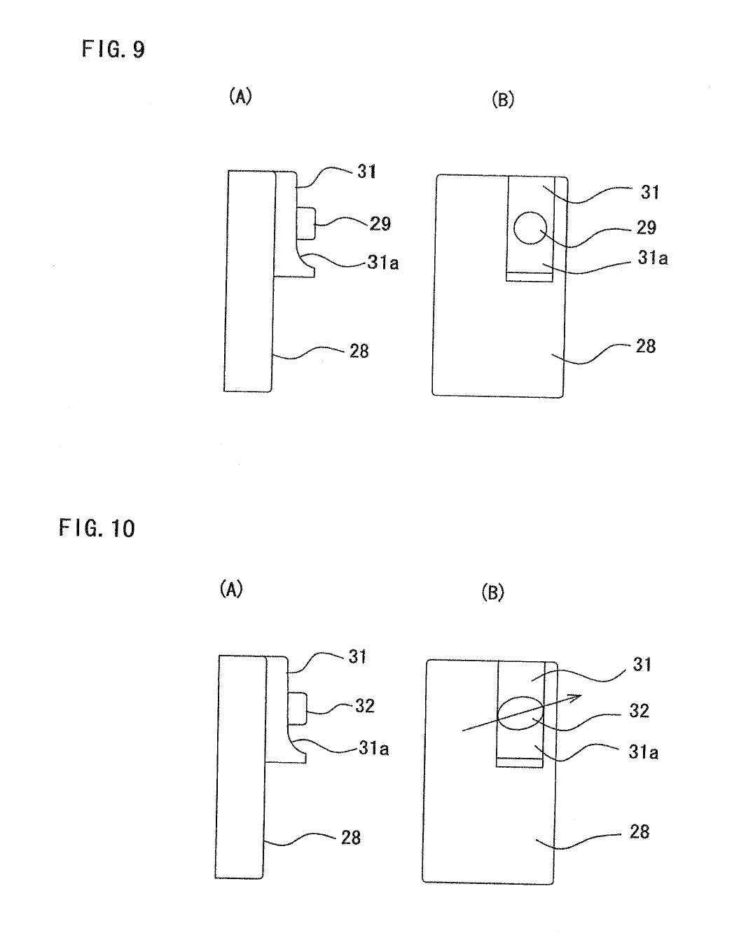

The case 28 of the controller and the fan casing 9 of the cooling fan device are slid in the axial direction of the motor to be inserted into the housing 2, and fixed in place. As illustrated in FIG. 8, a guide groove 9a through which the revolution detecting sensor 29 passes is formed along the axial direction of the motor shaft 6a in the fan casing 9. However, the existence of the guide groove 9a disturbs a flow of cooling air in the fan casing 9. As illustrated in FIGS. 9(A) and 9(B), the case 28 of the controller is provided with a shielding portion 31 which matches the guide groove 9a. The shielding portion 31 has a curved surface 31a which is flush with and continues into the inner surface of the fan casing 9. The revolution detecting sensor 29 projects from the curved surface 31a as such a small projection that the flow of cooling air is not disturbed.

Either one of the case 28 of the controller and the fan casing 9 of the cooling fan device is inserted into the housing 2 in the axial direction of the motor shaft 6a and then, the other one is inserted likewise. Thus, the shielding portion 31 of the case 28 is fitted into the guide groove 9a of the case 28 and fixed thereto. Accordingly, the curved surface which is flush with and continues into the inner side of the fan casing 9 is formed over the entire periphery. Cooling air produced by rotation of the cooling fan 8 smoothly and quietly flows. The revolution detecting sensor 29 projects into the flow path of cooling air as such a small projection that the flow of cooling air is not disturbed, and the revolution detecting sensor 29 is opposed to the proximity element 30 of the cooling fan 8 and produces a signal.

As illustrated in FIGS. 10(A) and 10(B), the revolution detecting sensor 32 may have a streamline shape extending in the flowing direction of cooling air sent by the cooling fan 8. In this case, cooling air produced by the rotation of the cooling fan 8 flows more smoothly and more quietly.

Function of the portable circular saw having the above-described structure will be described next.

An operator grasps the handle 14 and supports the portable circular saw. When the operator presses the switch lever 15 illustrated in FIGS. 2 and 3, the motor 6 is actuated, and the circular saw blade 1 rotates at a high speed in the direction of the arrow “a” in FIG. 2.

When the motor 6 is actuated, the soft start function is operated, and the circular saw blade 1 smoothly starts rotating.

As illustrated in FIG. 3, in the driving portion, the intermediate gears 7c and 7d are located rearward R1 from the plane P including the motor shaft 6a and the saw blade shaft 1a. With this arrangement, reaction of the housing 2 and the surface plate 4, which is produced by the rotation of the motor 6 and the circular saw blade 1 in the identical direction when the motor is actuated, is absorbed by the weight balance. Thus, in a state where the operator grasps the handle 14 with his or her hand, the housing 2 and the surface plate 4 are held at constant positions from the beginning of the actuation of the motor 6. When the surface plate 4 is brought into contact with a workpiece W and slid forward F1, the safe cover 16 is pushed by the workpiece W and comes into the cover 2c, and the workpiece W is cut by the circular saw blade 1.

### INDUSTRIAL APPLICABILITY

The cutting machine according to the invention is utilized for cutting a machining object.

1. A cutting machine comprising:
a motor having a motor shaft;
a circular saw blade having a saw blade shaft parallel to the motor shaft;
a housing accommodating the motor and the circular saw blade and having a handle at the rear thereof;
a surface plate connected to the housing;
a start end gear fixed to the motor shaft;
a terminal end gear fixed to the saw blade shaft; and
an intermediate gear located between the start end gear and the terminal end gear,
the start end gear, terminal end gear, and the intermediate gear being meshed each other to transmit, to the circular saw blade, rotation of the motor to be decelerated as rotation in the identical direction,
the intermediate gear being positioned rearward of the plane including the motor shaft and the saw blade shaft.

2. The cutting machine according to claim 1, wherein the terminal end gear is positioned rearward of the motor shaft.

3. The cutting machine according to claim 1, wherein the motor has a soft start function.

4. The cutting machine according to claim 2, wherein the motor has a soft start function.
